(19) United States
(12) Patent Application Publication
(10) Pub. No.: US 2016/0325730 A1
(43) Pub. Date: Nov. 10, 2016

(54) CONTROLLER, CONTROL METHOD AND CONTROL SYSTEM FOR A VEHICLE

(71) Applicant: TOYOTA JIDOSHA KABUSHIKI KAISHA, Toyota-shi (JP)

(72) Inventors: Tomohito ONO, Susono-shi (JP); Takahito ENDO, Susono-shi (JP); Yuji IWASE, Mishima-shi (JP); Makoto FUNAHASHI, Gotemba-shi (JP)

(73) Assignee: TOYOTA JIDOSHA KABUSHIKI KAISHA, Toyota-shi (JP)

(21) Appl. No.: 15/110,619

(22) PCT Filed: Jan. 5, 2015
(86) PCT No.: PCT/IB2015/000002

§ 371 Date: Jul. 8, 2016

(30) Foreign Application Priority Data
Jan. 9, 2014 (JP) 2014-002597

(51) Int. Cl. B60W 20/15; B60W 20/40; B60K 6/50; B60K 6/387; B60K 6/442; B60K 6/383

(52) U.S. Cl. CPC B60W 20/15; B60K 6/442; B60K 6/383; B60K 6/50; B60K 6/387; B60W 20/40; Y10S 903/913; Y10S 903/915; Y10S 903/914; B60Y 2200/92; B60Y 2300/60; B60Y 2300/182; B60Y 2300/18091

(57) ABSTRACT

A vehicle includes an engine (2), a rotary machine (MG2), at least one driving wheel (25), a transmission member (11) arranged between the engine (2) and the driving wheel (25), a clutch (CL1) having a first engagement element (32) connected to the transmission member (11) and a second engagement element (33) connected to the rotary machine (MG2), the clutch (CL1) being configured to engage or disengage the first engagement element (32) and the second engagement element (33), and a controller. The controller includes an electronic control unit (40) configured to perform an idling mode after the clutch (CL1) is disengaged while the vehicle is traveling. The idling mode is a mode in which the rotary machine (MG2) rotates in a state where the rotation speed of the second engagement (33) element is lower than the rotation speed of the first engagement element (32).

### BACKGROUND OF THE INVENTION

1. Field of the Invention

The present invention relates to a controller and a control method for a vehicle.

2. Description of Related Art

In the related art, a vehicle including a clutch is known. For example, Japanese Patent Application Publication No. 2013-96555 (JP 2013-96555 A) discloses a technique of a connection mechanism for a vehicle driving system which is provided with a mechanical connection and disconnection unit in which a sleeve or a pole can mesh with dog-teeth. JP 2013-96555 A also discloses a configuration in which the mechanical connection and disconnection unit is disposed between a second M/G 58 and a transmission gear 12a.

### SUMMARY OF THE INVENTION

For example, as described in JP 2013-96555 A, in a vehicle including a clutch capable of separating a rotary machine, the rotation of the rotary machine may be stopped by disengaging the clutch while the vehicle is traveling. On the other hand, when the rotary machine is used as a power source of the vehicle at the time of acceleration, it is necessary to raise the rotation speed of the rotary machine so as to be synchronized with the rotation speed of the clutch. When the time required for raising the rotation speed of the rotary machine extends, there is a possibility that acceleration responsiveness will degrade.

An object of the invention provides a controller for a vehicle and a control method for a vehicle that can suppress degradation of acceleration responsiveness.

According to a first aspect of the invention, there is provided a controller for a vehicle. The vehicle includes an engine, a rotary machine, at least one driving wheel, a transmission member arranged between the engine and the driving wheel, and a clutch including a first engagement element connected to the transmission member and a second engagement element connected to the rotary machine, the clutch being configured to engage or disengage the first engagement element and the second engagement element. The controller includes an electronic control unit configured to perform an idling mode after the clutch is disengaged while the vehicle is traveling. The idling mode is a mode in which the rotary machine rotates in a state where a rotation speed of the second engagement element is lower than a rotation speed of the first engagement element.

In the aspect, the electronic control unit may be configured to control a rotation speed of the rotary machine in response to the rotation speed of the first engagement element while performing the idling mode.

In the aspect, the electronic control unit may be configured to stop a rotation of the rotary machine when the rotation speed of the first engagement element is lower than a predetermined value while performing the idling mode.

In the aspect, the electronic control unit may be configured to control the rotary machine such that a differential rotation speed between the rotation speed of the first engagement element and the rotation speed of the second engagement element reaches a predetermined value while performing the idling mode.

In the aspect, the electronic control unit may be configured to stop a rotation of the rotary machine when the rotation speed of the first engagement element is lower than the predetermined value while performing the idling mode.

In the aspect, the electronic control unit may be configured to control the rotary machine so as to raise the rotation speed of the second engagement element when the electronic control unit determines that a braking operation is performed by a driver or when it is determined that a deceleration request is given.

According to a second aspect of the invention, there is provided a control method for a vehicle. The vehicle includes an engine, a rotary machine, at least one driving wheel, a transmission member arranged between the engine and the driving wheel, a clutch including a first engagement element connected to the transmission member and a second engagement element connected to the rotary machine, the clutch being configured to engage or disengage the first engagement element and the second engagement element, and an electronic control unit. The control method includes performing, by the electronic control unit, an idling mode after the clutch is disengaged while the vehicle is traveling. The idling mode is a mode in which the rotary machine rotates in a state where a rotation speed of the second engagement element is lower than a rotation speed of the first engagement element.

According to a third aspect of the invention, there is provided a control system for a vehicle. The vehicle includes an engine; a rotary machine; at least one driving wheel; a transmission member arranged between the engine and the driving wheel, and a clutch including a first engagement element connected to the transmission member and a second engagement element connected to the rotary machine, the clutch being configured to engage or disengage the first engagement element and the second engagement element; and an electronic control unit. The electronic control unit is configured to perform an idling mode after the clutch is disengaged while the vehicle is traveling, the idling mode being a mode in which the rotary machine rotates in a state where a rotation speed of the second engagement element is lower than a rotation speed of the first engagement element.

In the aspect, the control system may include a one-way clutch disposed in parallel to the clutch. The one-way clutch may be configured to be disengaged while performing the idling mode.

According to the first aspect, the second aspect, and the third aspect, it is possible to suppress degradation of acceleration responsiveness.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart illustrating transition determination of a vehicle controller according to an embodiment of the invention;

FIG. 2 is a flowchart illustrating return determination of the vehicle controller according to the embodiment;

FIG. 3 is a diagram schematically illustrating a configuration of a vehicle according to the embodiment;

FIG. 4 is a skeleton diagram of the vehicle according to the embodiment;

FIG. 5 is a block diagram illustrating the vehicle controller according to the embodiment;

FIG. 6 is a collinear diagram illustrating an example of a traveling state according to the embodiment;

FIG. 7 is a collinear diagram illustrating another example of the traveling state according to the embodiment;

FIG. 8 is a collinear diagram illustrating still another example of the traveling state according to the embodiment;

FIG. 9 is a diagram illustrating an operation engagement table according to the embodiment;

FIG. 10 is a diagram illustrating a rotating state in a rest mode;

FIG. 11 is a diagram illustrating a target rotation speed;

FIG. 12 is a timing chart illustrating control according to the embodiment;

FIG. 13 is a skeleton diagram illustrating a vehicle according to a first modification example of the embodiment;

FIG. 14 is a skeleton diagram illustrating a vehicle according to a second modification example of the embodiment;

FIG. 15 is a diagram schematically illustrating a configuration of a vehicle according to a third modification example of the embodiment;

FIG. 16 is a skeleton diagram illustrating a vehicle according to the third modification example of the embodiment;

FIG. 17 is a diagram illustrating another configuration of the vehicle according to the third modification example of the embodiment;

FIG. 18 is a skeleton diagram illustrating a vehicle according to a fourth modification example of the embodiment; and

FIG. 19 is a diagram illustrating an idling mode according to a fifth modification example of the embodiment.

### DETAILED DESCRIPTION OF EMBODIMENTS

Hereinafter, a vehicle controller according to an embodiment of the invention will be described in detail with reference to the accompanying drawings. The invention is not limited to the embodiment. Elements in the below embodiment include elements that can be easily conceived of by those skilled in the art or elements that are substantially identical thereto.

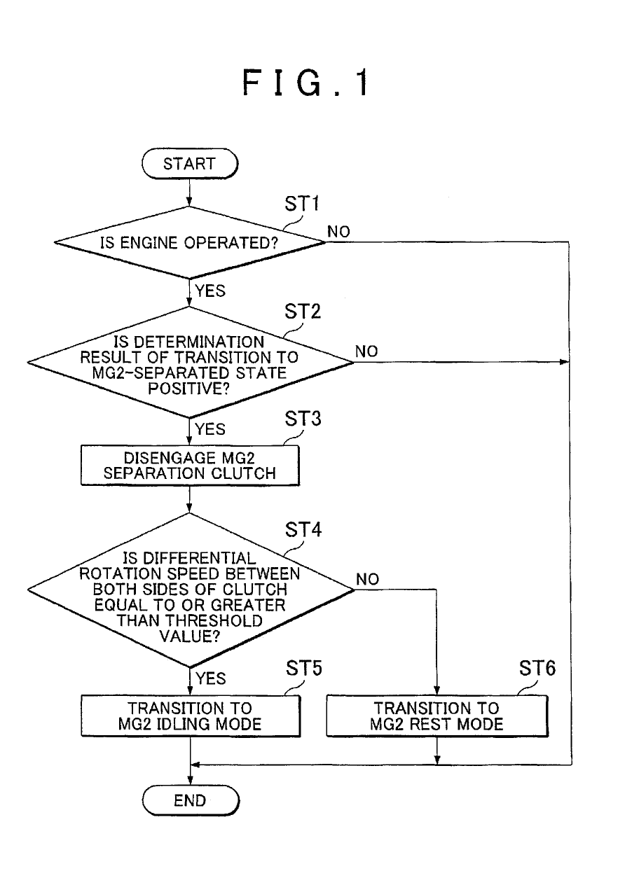

The embodiment of the invention will be described below with reference to FIGS. 1 to 12. This embodiment provides a vehicle controller.

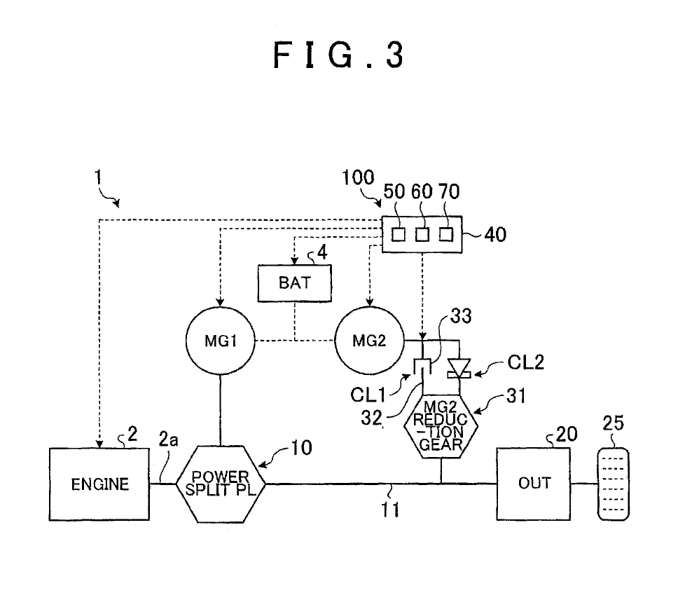

As illustrated in FIG. 3, a vehicle 1 according to this embodiment includes an engine 2, a first rotary machine MG1, a second rotary machine MG2, a battery 4, a planetary gear mechanism 10, a transmission member 11, a first clutch CL1, a second clutch CL2, a control unit 40, and an output shaft 20. The vehicle 1 is a hybrid vehicle having the engine 2 and two rotary machines MG1, MG2 as drive sources. The vehicle 1 may be a plug-in hybrid vehicle (PHV) that can be charged with an external power source.

A vehicle control system 100 according to this embodiment includes the engine 2, the second rotary machine MG2, the transmission member 11, the first clutch CL1, the second clutch CL2, and the control unit 40 in the vehicle 1.

The engine 2 converts the combustion energy of fuel into the rotation of an output shaft 2a and outputs the rotation. The planetary gear mechanism 10 has a function as a power split planetary that splits the power output from the engine 2 into the output shaft 20 and the first rotary machine MG1. The first rotary machine MG1 and the second rotary machine MG2 have a function as a motor (electric motor) and a function as a power generator. The first rotary machine MG1 and the second rotary machine MG2 are connected to the battery 4 via an inverter. The power generated by the rotary machines MG1, MG2 can be stored in the battery 4. For example, a three-phase AC synchronization type motor-generator set can be used as the first rotary machine MG1 and the second rotary machine MG2.

The first clutch CL1 is a clutch unit that is disposed between the transmission member 11 and the second rotary machine MG2 and that can be arbitrarily switched to an engaged state or a disengaged state. Here, the transmission member 11 is arranged between the engine 2 and the driving wheels 25. The second clutch CL2 is a one-way clutch disposed in parallel to the first clutch CL1. For example, a sprag type one-way clutch can be used as the second clutch CL2.

The second rotary machine MG2 transmits and receives power to and from the transmission member 11 via at least one of the first clutch CL1 or the second clutch CL2. The power output from the engine 2 and the second rotary machine MG2 to the transmission member 11 is transmitted to the driving wheels 25 via the output shaft 20.

The vehicle control system 100 according to this embodiment has a rest mode in which the vehicle 1 travels forward with the rotation of the second rotary machine MG2 stopped. In the rest mode, the first clutch CL1 is in the disengaged state. Since the first clutch CL1 is disengaged and the second rotary machine MG2 is separated from the transmission member 11, the rotation of the second rotary machine MG2 along with the rotation of the transmission member 11 is suppressed and thus a dragging loss or a mechanical loss in the second rotary machine MG2 is reduced. Since the loss occurring in the second rotary machine MG2 is reduced, the output power of the engine 2 can be reduced by the loss. Accordingly, the vehicle control system 100 according to this embodiment can achieve a decrease in loss or an improvement in fuel efficiency of the vehicle 1.

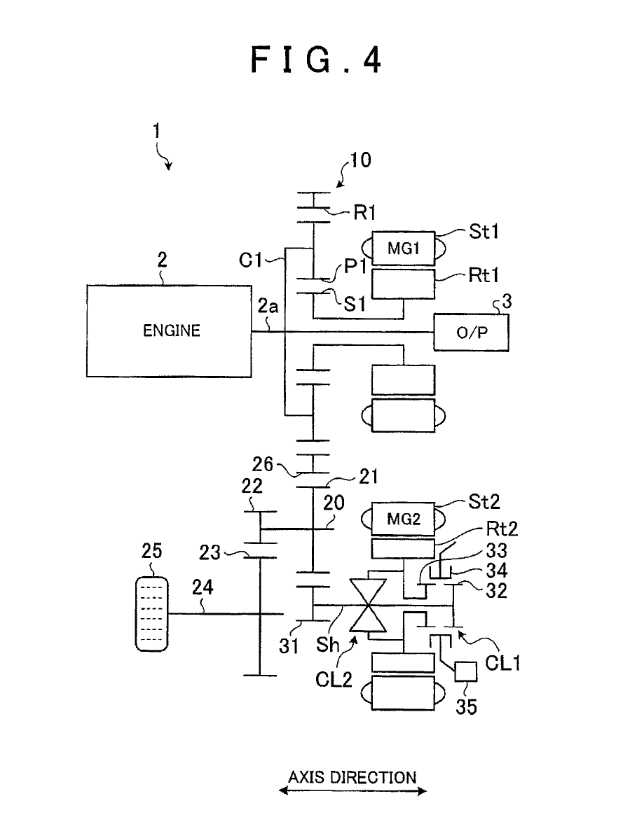

An example of the specific configuration of the vehicle 1 will be described below with reference to FIG. 4. As illustrated in FIG. 4, the output shaft 2a of the engine 2 is connected to a carrier C1 of the planetary gear mechanism 10. The planetary gear mechanism 10 is a single-pinion planetary gear mechanism. The planetary gear mechanism 10 includes a sun gear S1, a pinion gear P1, a ring gear R1, and a carrier C1. The planetary gear mechanism 10 is disposed between the engine 2 and the first rotary machine MG1 in the axis direction of the output shaft 2a. The planetary gear mechanism 10 and the first rotary machine MG1 are arranged coaxial with the engine 2. The axis direction of the engine 2 is parallel to, for example, a vehicle width direction.

The first rotary machine MG1 includes a rotor Rt1 that is rotatably supported and a stator St1 that is fixed to a vehicle body side. The sun gear S1 is connected to the rotor Rt1 of the first rotary machine MG1 and rotates along with the rotor Rt1. An output gear 26 disposed on the outer circumference of the ring gear R1 engages with a driven gear 21. The driven gear 21 is a gear connected to the output shaft 20. The output shaft 20 is a shaft parallel to the output shaft 2a of the engine 2 and a rotation shaft Sh to be described later. A drive pinion gear 22 is connected to the output shaft 20. The drive pinion gear 22 engages with a final gear 23. The final gear 23 is connected to the driving wheels 25 via a drive shaft 24. A differential gear may be disposed between the final gear 23 and the drive shaft 24.

A reduction gear 31 engages with the driven gear 21. The reduction gear 31 is connected to the rotation shaft Sh. The second rotary machine MG2 is disposed coaxial with the rotation shaft Sh. The second rotary machine MG2 includes a rotor Rt2 that is rotatably supported and a stator St2 that is fixed to the vehicle body side. The first clutch CL1 and the second clutch CL2 are disposed between the rotation shaft Sh and the rotor Rt2 of the second rotary machine MG2.

The first clutch CL1 in this embodiment is a meshing type dog clutch. The first clutch CL1 includes first dog-teeth 32, second dog-teeth 33, a sleeve 34, and an actuator 35. The first dog-teeth 32 are dog-teeth connected to the rotation shaft Sh and are an example of the first engagement element. The second dog-teeth 33 are dog-teeth connected to the rotor Rt2 of the second rotary machine MG2 and are an example of the second engagement element. The first dog-teeth 32 and the second dog-teeth 33 are, for example, teeth extending linearly in the axis direction of the rotation shaft Sh. The sleeve 34 is supported to be movable in the axis direction of the rotation shaft Sh. The sleeve 34 has dog-teeth corresponding to the first dog-teeth 32 and the second dog-teeth 33.

The actuator 35 moves the sleeve 34 in the axis direction of the rotation shaft Sh to engage or disengage the first clutch CL1. The first clutch CL1 in this embodiment is a normally-open type clutch and is switched to the disengaged state when the actuator 35 does not generate a drive force. The actuator 35 drives the sleeve 34 in one direction (engagement direction) of the axis direction, for example, with an electromagnetic force. On the other hand, the sleeve 34 is impelled in the direction (disengagement direction) opposite to the direction of the drive force based on the actuator 35 with an impelling member such as a spring. Accordingly, the sleeve 34 is maintained in the disengaged state with the impelling force of the impelling member when the actuator 35 does not generate a drive force.

The actuator 35 moves the sleeve 34 in the engagement direction with the generated drive force against the impelling force so as to cause the sleeve 34 to engage with both the first dog-teeth 32 and the second dog-teeth 33. Accordingly, the first dog-teeth 32 and the second dog-teeth 33 engage with each other via the sleeve 34 and thus the first clutch CL1 is switched to the engaged state. When the first clutch CL1 is engaged, the rotation shaft Sh and the rotor Rt2 are connected via the sleeve 34 so as to rotate together. That is, in the first clutch CL1, the first dog-teeth 32 and the second dog-teeth 33 can be arbitrarily engaged or disengaged by moving the sleeve 34 through the use of the actuator 35.

In this embodiment, the same direction as the rotation direction of the rotation shaft Sh when the vehicle 1 travels forward out of both rotation directions of the second rotary machine MG2 is referred to as a “positive rotation direction” and the reverse rotation direction of the positive rotation direction is referred to as a “negative rotation direction” or a “reverse rotation direction”. Out of the torques of the second rotary machine MG2, the torque in the same direction as the positive rotation direction of the second rotary machine MG2 is referred to as a “positive torque” and the torque in the reverse direction of the positive rotation direction of the second rotary machine MG2 is referred to as a “negative torque” or a “reverse torque”. That is, the positive torque is a torque in the direction in which the absolute value of the rotation speed of the second rotation machine MG2 increases. On the other hand, the negative torque is a torque in the direction in which the absolute value of the rotation speed of the second rotary machine MG2 decreases, that is, in the direction in which the rotation of the second rotary machine MG2 decreases.

The second clutch CL2 can transmit the torque in the positive rotation direction from the second rotary machine MG2 to the rotation shaft Sh and intercepts the torque in the negative rotation direction. On the other hand, the second clutch CL2 can transmit the torque in the negative rotation direction from the rotation shaft Sh to the second rotary machine MG2 and intercepts the torque in the positive rotation direction.

An oil pump 3 is connected to the output shaft 2a of the engine 2. The oil pump 3 ejects oil with the rotation of the engine 2. The oil pump 3 supplies oil to a power transmission part including the first rotary machine MG1 and the second rotary machine MG2. The oil supplied by the oil pump 3 lubricates and cools the first rotary machine MG1 and the second rotary machine MG2. The oil pump 3 may supply oil to a lubricated part including the planetary gear mechanism 10.

As described above, in the vehicle 1 according to this embodiment, the first rotary machine MG1 is connected to the sun gear S1 of the planetary gear mechanism 10, and the engine 2 is connected to the carrier C1. The ring gear R1 is connected to the driving wheels 25 and the second rotary machine MG2. The planetary gear mechanism 10 serves as a power split mechanism distributing the output power of the engine 2 into the driving wheels 25 and the first rotary machine MG1. The rotation of the engine 2 is raised in speed and is transmitted to the ring gear R1 by the planetary gear mechanism 10.

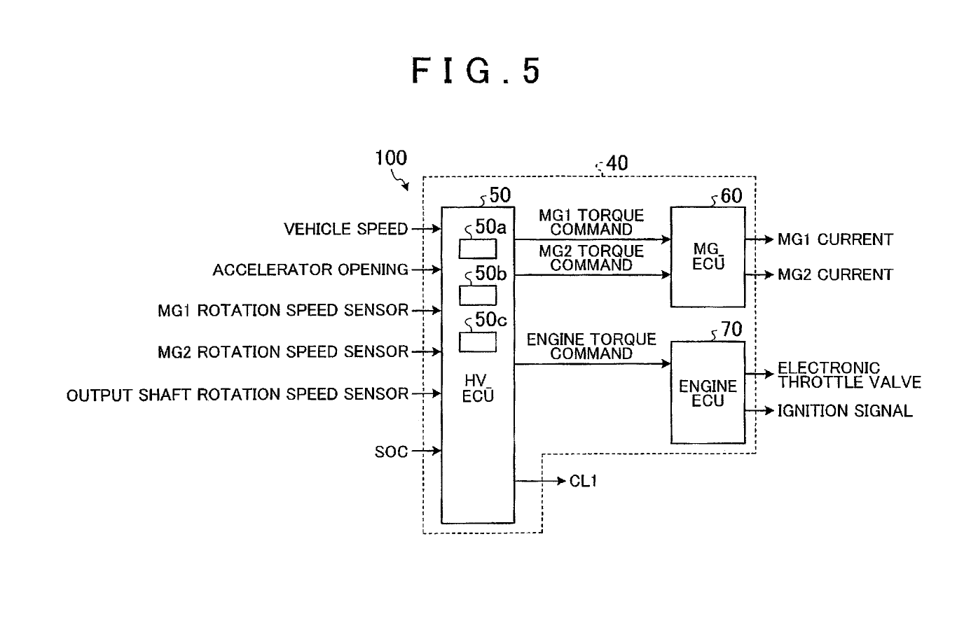

As illustrated in FIG. 5, the control unit 40 includes an HV_ECU 50, an MG_ECU 60, and an engine ECU 70. The control unit 40 has a function of controlling the traveling of the vehicle 1. The ECUs 50, 60, and 70 are, for example, electronic control units having a computer. The HV_ECU 50 has a function of comprehensively controlling the entire vehicle 1. The MG_ECU 60 and the engine ECU 70 are electrically connected to the HV_ECU 50.

The MG_ECU 60 can control the first rotary machine MG1 and the second rotary machine MG2. For example, the MG_ECU 60 adjusts a current value supplied to the first rotary machine MG1 so as to control the output torque of the first rotary machine MG1. For example, the MG_ECU 60 adjusts a current value supplied to the second rotary machine MG2 so as to control the output torque of the second rotary machine MG2.

For example, the engine ECU 70 can perform controlling an electronic throttle valve of the engine 2, outputting an ignition signal to control the ignition of the engine 2, and controlling injection of fuel into the engine 2.

A vehicle speed sensor, an accelerator opening sensor, an MG1 rotation speed sensor, an MG2 rotation speed sensor, an output shaft rotation speed sensor, a battery sensor, and the like are connected to the HV_ECU 50. The HV_ECU 50 can acquire a vehicle speed, an accelerator opening, a rotation speed of the first rotary machine MG1, a rotation speed of the second rotary machine MG2, a rotation speed of the output shaft 20, a battery state SOC, and the like from the sensors.

The HV_ECU 50 includes a drive force calculating unit 50a, a mode determining unit 50b, and a cutoff mode instructing unit 50c. The drive force calculating unit 50a calculates a request drive force for the vehicle 1 on the basis of information acquired by the HV_ECU 50. The drive force calculating unit 50a may calculate request power, a request torque, and the like instead of the request drive force. The HV_ECU 50 determines the output torque of the first rotary machine MG1 (hereinafter, also referred to as “MG1 torque”), the output torque of the second rotary machine MG2 (hereinafter, also referred to as “MG2 torque”), and the output torque of the engine 2 (hereinafter, also referred to as “engine torque”) on the basis of the request value calculated by the drive force calculating unit 50a. The HV_ECU 50 outputs a command value of the MG1 torque and a command value of the MG2 torque to the MG_ECU 60. The HV_ECU 50 outputs a command value of the engine torque to the engine ECU 70.

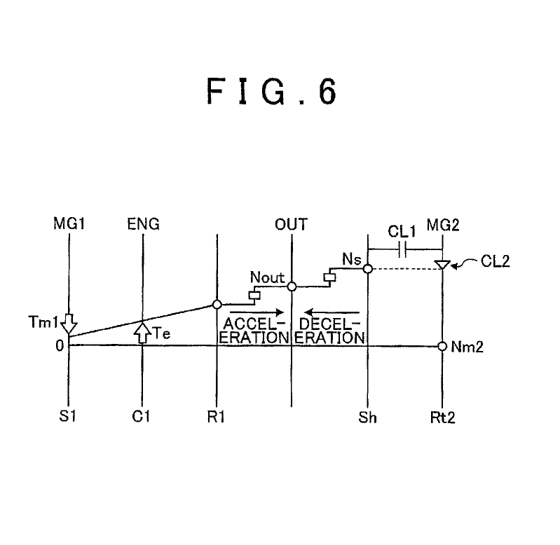

The traveling state of the vehicle 1 will be described below with reference to the accompanying drawings. In the collinear diagrams illustrated in FIGS. 6 to 8, the S1 axis represents the rotation speed of the sun gear S1 and the first rotary machine MG1, the C1 axis represent the rotation speeds of the carrier C1 and the engine 2, and the R1 axis represents the rotation speed of the ring gear R1. The OUT axis represents the rotation speed of the output shaft 20. The Sh axis represents the rotation speed of the rotation axis Sh and the Rt2 axis represents the rotation speed of the rotor Rt2 of the second rotary machine MG2. In the below description, the rotation speed of the rotation shaft Sh is referred to as “shaft rotation speed Ns”, and the rotation speed of the rotor Rt2 is referred to as “MG2 rotation speed Nm2”. The rotation speed of the output shaft 20 is referred to as “output shaft rotation speed Nout”.

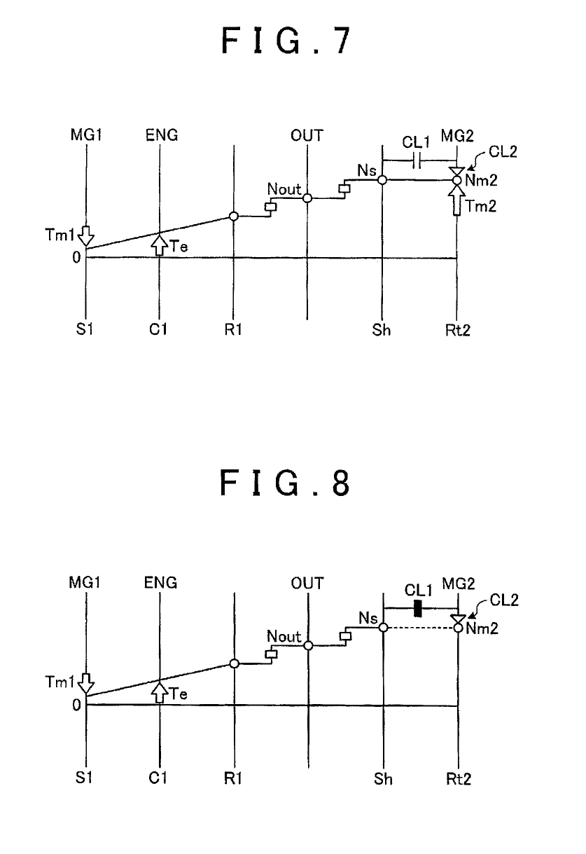

FIGS. 6 and 7 illustrate a state where the first clutch CL1 is disengaged and FIG. 8 illustrates a state where the first clutch CL1 is engaged.

In the vehicle 1 according to this embodiment, as illustrated in FIG. 4, the outer diameter of the ring gear R1 is greater than the outer diameter of the driven gear 21. Accordingly, the rotation of the ring gear R1 is increased in speed and is then transmitted to the output shaft 20. The outer diameter of the reduction gear 31 is smaller than the outer diameter of the driven gear 21. Accordingly, the shaft rotation speed Ns of the rotation shaft Sh is decreased and is then transmitted to the output shaft 20. That is, the reduction gear 31 is a gear that can decrease and transmit the MG2 rotation speed Nm2 to the output shaft 20.

The second clutch CL2 is switched to the disengaged state as illustrated in FIG. 6 when the MG2 rotation speed Nm2 is lower than the shaft rotation speed Ns (including a case in which the second rotary machine MG2 rotates negatively) while the vehicle 1 travels forward. On the other hand, the second clutch CL2 is switched to the engaged state as illustrated in FIG. 7 and transmits power from the second rotary machine MG2 to the rotation shaft Sh when the MG2 rotation speed Nm2 is synchronized with the shaft rotation speed Ns. That is, when the vehicle 1 travels forward and the MG2 rotation speed Nm2 is increased by setting the MG2 torque Tm2 to the positive torque, the second clutch CL2 is engaged. Accordingly, the MG2 torque is transmitted to the rotation shaft Sh via the second clutch CL2.

When the MG2 rotation speed Nm2 is lower than the shaft rotation speed Ns while the vehicle travels forward, the second clutch CL2 is switched to the disengaged state. That is, when the rotation speed of the second rotary machine MG2 is decreased from the state in which the vehicle travels forward using the second rotary machine MG2 as a drive source by powering the second rotary machine MG2, the second clutch CL2 is switched from the engaged state to the disengaged state. Accordingly, when the first clutch CL1 is in the disengaged state, the second clutch CL2 can be switched to the disengaged state by decreasing the rotation speed of the second rotary machine MG2. When the second clutch CL2 is in the disengaged state, the second rotary machine MG2 is separated from the transmission member 11. Accordingly, the vehicle 1 can also run with the rotation of the second rotary machine MG2 stopped.

As illustrated in FIG. 8, when the first clutch CL1 is in the engaged state, a torque in any rotation direction can be transmitted between the second rotary machine MG2 and the rotation shaft Sh. Accordingly, when the vehicle travels forward with the first clutch CL1 in the engaged state, the vehicle 1 can be accelerated with the positive torque output from the second rotary machine MG2 and the vehicle 1 can be braked or regenerate energy by causing the second rotary machine MG2 to generate a negative torque.

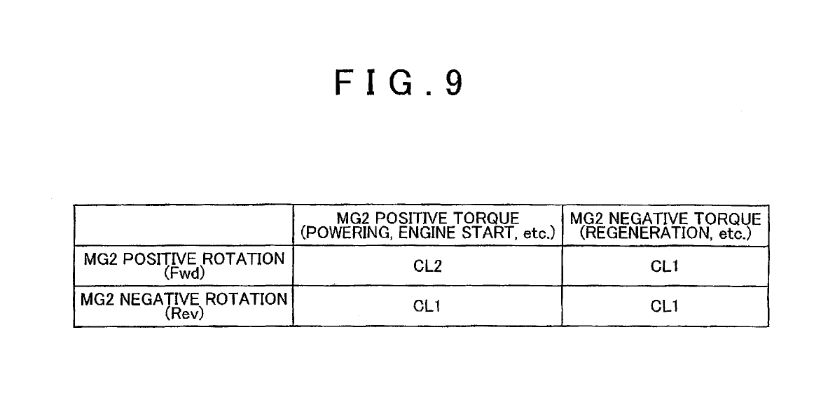

The control unit 40 controls engagement or disengagement of the first clutch CL1, for example, as illustrated in FIG. 9. FIG. 9 illustrates combinations of the positive and negative signs of the rotation direction of the second rotary machine MG2, the positive and negative signs of the torque, and the clutches in the engaged state. When the second rotary machine MG2 rotates positively and the MG2 torque is a positive torque, that is, when the vehicle travels forward using the second rotary machine MG2 as a drive source or when the engine 2 is started with the MG2 torque, the first clutch CL1 is in the disengaged state. Accordingly, the second clutch CL2 is engaged when power is transmitted from the second rotary machine MG2 to the transmission member 11.

When the second rotary machine MG2 rotates positively and the MG2 torque is a negative torque, that is, when the torque in the braking direction is output from the second rotary machine MG2 while the vehicle travels forward, the first clutch CL1 is engaged. Accordingly, the braking torque output from the second rotary machine MG2 is transmitted to the transmission member 11 via the first clutch CL1 and the regenerative power generation of the second rotary machine MG2 and the like is performed.

When the second rotary machine MG2 rotates negatively and the MG2 torque is a positive torque, that is, when the vehicle travels reversely with the second rotary machine MG2 as a drive source, the first clutch CL1 is engaged. Accordingly, the torque in the negative rotation direction from the second rotary machine MG2 is transmitted to the transmission member 11 via the first clutch CL1 and the vehicle 1 can be driven to run reverse with the MG2 torque.

When the second rotary machine MG2 rotates negatively and the MG2 torque is a negative torque, for example, when the torque in the braking direction is output from the second rotary machine MG2 while the vehicle travels reversely, the first clutch CL1 is engaged. In this combination of the rotation direction and the torque direction, the second clutch CL2 is engaged in principle. Accordingly, it may be considered that the first clutch CL1 is in the disengaged state. However, the case of this combination of the rotation direction and the torque is typically a case in which the braking operation is performed at the time of running reversely, and the occurrence frequency thereof is small. At the time of running reversely, the ON and OFF states of the brake may be frequently switched to each other. When the engagement and the disengagement of the first clutch CL1 are repeated whenever the ON and OFF states of the brake are switched, the control becomes complicated, which is not desirable. Accordingly, in this embodiment, when the second rotary machine MG2 rotates negatively as described above, the first clutch CL1 is maintained in the engaged state.

The mode determining unit 50b of the HV_ECU 50 selects an HV running mode or an EV running mode on the basis of the calculated request drive force, the calculated vehicle speed, or the like. The HV running mode is a running mode in which the vehicle 1 travels with at least the engine 2 as a drive source. In the HV running mode, the first rotary machine MG1 can serve as a part receiving a reaction force against the engine torque. The first rotary machine MG1 generates a reaction torque Tm1 against the engine torque Te and outputs power of the engine 2 from the ring gear R1, for example, as illustrated in FIG. 6. The power of the engine 2 output from the ring gear R1 is transmitted from the output shaft 20 to the driving wheels 25.

In the HV running mode, the first clutch CL1 is, for example, in the disengaged state. Since the first clutch CL1 is of a normally-opened type, the first clutch CL1 does not consume electric power in the disengaged state. Accordingly, by performing the HV running mode with the first clutch CL1 set to the disengaged state, it is possible to reduce power consumption.

In the HV running mode, the vehicle 1 may run with the second rotary machine MG2 in addition to the engine 2 as a drive source. When the second rotary machine MG2 is used as the drive source at the time of running forward, the HV_ECU 50 causes the second rotary machine MG2 to rotate positively and to output a positive torque. When the MG2 rotation speed Nm2 increases and is synchronized with the shaft rotation speed Ns, the second clutch CL2 is engaged. Accordingly, the power of the second rotary machine MG2 is transmitted to the output shaft 20 via the second clutch CL2 and the rotation shaft Sh.

The HV_ECU 50 can cause the second rotary machine MG2 to perform regenerative power generation in the HV running mode. When the second rotary machine MG2 performs regenerative power generation, the HV_ECU 50 switches the first clutch CL1 to the engaged state. When the second clutch CL2 is already engaged, the engaging operation of the first clutch CL1 can be started without any change in that the MG2 rotation speed Nm2 is synchronized with the shaft rotation speed Ns. When the first clutch CL1 is engaged, the HV_ECU 50 causes the second rotary machine MG2 to generate a negative torque (torque in the reverse direction of the rotation direction) and causes the second rotary machine MG2 to generate power.

The EV running mode is a running mode in which the vehicle 1 travels with the second rotary machine MG2 as a drive source. When the vehicle 1 travels forward in the EV running mode, the first clutch CL1 is, for example, in the disengaged state. The HV_ECU 50 causes the second rotary machine MG2 to output the torque in the positive rotation direction and to rotate positively. Accordingly, the second clutch CL2 is engaged and the positive torque output from the second rotary machine MG2 drives the vehicle 1 to move forward. The HV_ECU 50 sets the first rotary machine MG1 to a free state in which the first rotary machine MG1 performs neither powering nor regenerative power generation in the EV running mode. Accordingly, in the EV running mode, the engine 2 stops the rotation thereof and the first rotary machine MG1 idles.

The HV_ECU 50 can cause the second rotary machine MG2 to perform regenerative power generation in the EV running mode. When the second rotary machine MG2 performs regenerative power generation, the HV_ECU 50 switches the first clutch CL1 to the engaged state. When the first clutch CL1 is engaged, the HV_ECU 50 causes the second rotary machine MG2 to generate a negative torque (torque in the reverse direction of the rotation direction) and causes the second rotary machine MG2 to generate power.

The vehicle control system 100 according to this embodiment has a rest mode, an idling mode, and a return mode. The rest mode and the idling mode are running modes in which the vehicle 1 travels with the first clutch CL1 disengaged and with the power transmission between the transmission member 11 and the second rotary machine MG2 intercepted. In this embodiment, the rest mode and the idling mode are generically referred to as an “MG cutoff mode”. The return mode is a running mode in course of returning from the MG cutoff mode.

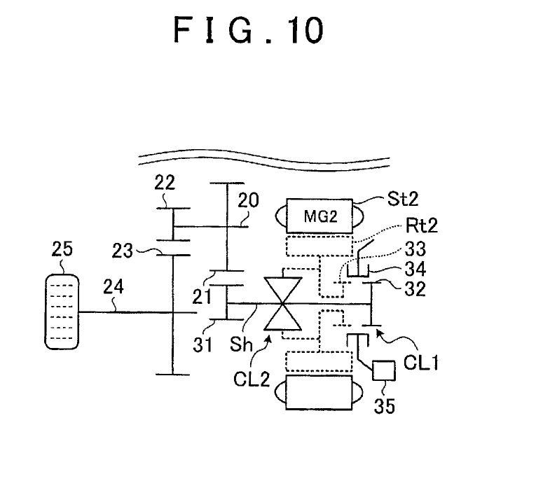

The rest mode is a running mode in which the vehicle travels using the engine 2 as a drive source with the first clutch CL1 in the disengaged state and with the second rotary machine MG2 stopped. The rest mode may be considered to be an example of the HV running mode. In FIG. 10, the rotary element indicated by a dotted line stops the rotation thereof in the rest mode. That is, the rotor Rt2 of the second rotary machine MG2 and the second dog-teeth 33 stop the rotations thereof in the rest mode. On the other hand, the rotation shaft Sh and the first dog-teeth 32 continue to rotate while the vehicle travels even in the rest mode.

Since the second rotary machine MG2 is stopped in the rest mode, a dragging loss, a mechanical loss, an electrical loss, and the like of the second rotary machine MG2 is reduced. Here, the state in which the second rotary machine MG2 is stopped in the rest mode includes a state in which the MG2 rotation speed Nm2 is zero, a state in which the second rotary machine MG2 rotates at the MG2 rotation speed Nm2 which is a low rotation speed (for example, several tens of rpm) equal to or less than a detection limit of the MG2 rotation speed sensor, and the like.

The rotation shaft Sh and the first dog-teeth 32 are rotary elements that rotate in conjunction with the rotation of the driving wheels 25. In the vehicle 1 according to this embodiment, the first dog-teeth 32 are connected to the driving wheels 25 without passing through a transmission mechanism or the like and the gear ratio of the driving wheels 25 and the first dog-teeth 32 does not vary. Accordingly, the rotation shaft Sh and the dog-teeth 32 rotate at a rotation speed proportional to the vehicle speed. As a result, the higher the vehicle speed in the rest mode becomes, the larger the difference in rotation speed between the first dog-teeth 32 and the stopped second dog-teeth 33 becomes.

In order to return from the rest mode to the running mode in which the second rotary machine MG2 is used as a drive source, it is necessary to increase the MG2 rotation speed Nm2 to the shaft rotation speed Ns and to synchronize the rotation speed of the first dog-teeth 32 with the rotation speed of the second dog-teeth 33. The time required for increasing the MG2 rotation speed Nm2 becomes longer as the differential rotation speed between the shaft rotation speed Ns and the MG2 rotation speed Nm2 in the rest mode becomes larger. When the time required for returning from the rest mode is excessively long, the responsiveness to a driver's acceleration request may degrade, thereby causing a decrease in drivability. On the contrary, the vehicle control system 100 according to this embodiment includes the idling mode. The vehicle control system 100 can suppress the degradation in responsiveness by the idling mode as will be described below.

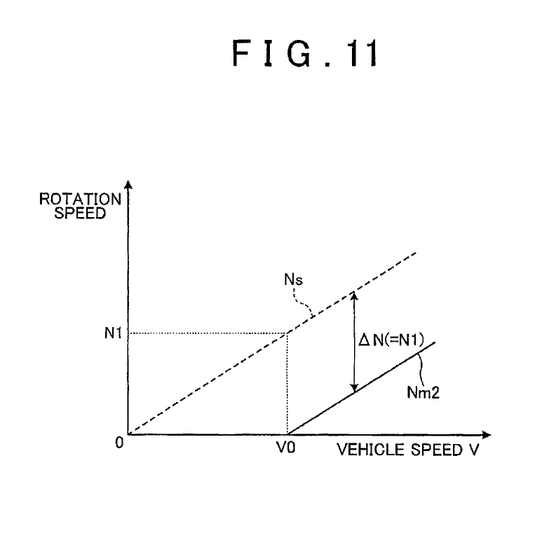

The idling mode is a running mode in which the second rotary machine MG2 rotates such that the rotation speed of the second dog-teeth 33 is lower than the rotation speed of the first dog-teeth 32 after the first clutch CL1 is disengaged while the vehicle travels. In this embodiment, for example, the MG2 rotation speed Nm2 is controlled, for example, as described with reference to FIG. 11.

In FIG. 11, the horizontal axis represents the vehicle speed and the vertical axis represents the rotation speed. In this embodiment, the MG2 rotation speed Nm2 is controlled so that the differential rotation speed ΔN between the rotation speed of the first dog-teeth 32 and the rotation speed of the second dog-teeth 33 is equal to a predetermined rotation speed N1. In this embodiment, the rotation speed of the first dog-teeth 32 is equal to the shaft rotation speed Ns and the rotation speed of the second dog-teeth 33 is equal to the MG2 rotation speed Nm2. Accordingly, in description of the control details, the shaft rotation speed Ns is used as a value indicating the rotation speed of the first dog-teeth 32 and the MG2 rotation speed Nm2 is used as a value indicating the rotation speed of the second dog-teeth 33.

In FIG. 11, the shaft rotation speed Ns and the target value of the MG2 rotation speed Nm2 depending on the shaft rotation speed Ns are illustrated. The shaft rotation speed Ns is indicated by a dotted line, and the target value of the MG2 rotation speed Nm2 is indicated by a solid line. As illustrated in FIG. 11, the control unit 40 controls the MG2 rotation speed Nm2 depending on the shaft rotation speed Ns in the idling mode. Specifically, the target value of the MG2 rotation speed Nm2 is determined to be lower than the shaft rotation speed Ns so that the differential rotation speed ΔN form the shaft rotation speed Ns is a desired value. In this embodiment, a predetermined rotation speed N1 is determined in advance as the target value of the differential rotation speed ΔN. The control unit 40 controls the second rotary machine MG2 in the idling mode on the basis of the map illustrated in FIG. 11 so as to set the differential rotation speed ΔN between the shaft rotation speed Ns and the MG2 rotation speed Nm2 to the predetermined rotation speed N1. The predetermined rotation speed N1 is, for example, a constant value not depending on the vehicle speed. In the idling mode, since the MG2 rotation speed Nm2 is lower than the shaft rotation speed Ns, the second clutch CL2 is disengaged.

A predetermined vehicle speed V0 is a value of the vehicle speed at which the value of the shaft rotation speed Ns is equal to the predetermined rotation speed N1. Accordingly, the idling mode is performed when the vehicle speed is higher than the predetermined vehicle speed V0. On the other hand, in a zone in which the vehicle speed is equal to or lower than the predetermined vehicle speed V0, the rest mode is performed and the rotation of the second rotary machine MG2 is stopped. That is, the control unit 40 stops the second rotary machine MG2 when the shaft rotation speed Ns is lower than the predetermined rotation speed N1.

The predetermined rotation speed N1 in this embodiment is determined on the basis of the time required for increasing the MG2 rotation speed Nm2 by the predetermined rotation speed N1. The response time until the MG2 torque Tm2 is transmitted to the driving wheels 25 after the driver performs an acceleration operation is determined depending on the time required for increasing the MG2 rotation speed Nm2 to the shaft rotation speed Ns. The predetermined rotation speed N1 is determined in advance on the basis of experiment results and the like so as to secure appropriate acceleration responsiveness.

The return mode is a mode to which the operation is returned from the rest mode or the idling mode. The return mode is a mode in which the MG2 rotation speed Nm2 is increased to be synchronized with the shaft rotation speed Ns and power is able to be transmitted from the second rotary machine MG2 to the transmission member 11. When the MG2 rotation speed Nm2 is synchronized with the shaft rotation speed Ns, the second clutch CL2 is engaged. Accordingly, the running mode in which the second rotary machine MG2 is used as a drive source can be performed. For example, the HV running mode in which the engine 2 and the second rotary machine MG2 are used as a drive source can be performed. The first clutch CL1 may be engaged in a state where the MG2 rotation speed Nm2 is synchronized with the shaft rotation speed Ns. By engaging the first clutch CL1, the second rotary machine MG2 can also perform regenerative power generation.

A difference in control of the second rotary machine MG2 between the idling mode and the return mode will be described below. In the return mode, the MG2 rotation speed Nm2 is controlled so that the MG2 rotation speed Nm2 is synchronized with the shaft rotation speed Ns. That is, in the return mode, the control of increasing the MG2 rotation speed Nm2 to the shaft rotation speed Ns is performed. On the other hand, the target value of the MG2 rotation speed Nm2 in the idling mode is always lower than the shaft rotation speed Ns. That is, the idling mode is different from the return mode, in that the increase of the MG2 rotation speed Nm2 ends when the MG2 rotation speed Nm2 becomes the target rotation speed.

In the return mode, it is preferable that the time required for synchronizing the rotation speeds be as short as possible. Accordingly, the increase rate of the MG2 rotation speed Nm2 in the return mode is relatively high. On the other hand, in the idling mode, a scene in which the MG2 rotation speed Nm2 is raised at a high increase rate is rare. For example, the scene in which the MG2 rotation speed Nm2 is increased in the idling mode is a case in which the target value of the MG2 rotation speed Nm2 increases with the increase in the vehicle speed. In this case, the increase rate of the MG2 rotation speed Nm2 is relatively small to correspond to the increase in the vehicle speed. Particularly, in this embodiment, the idling mode is allowed when the request drive force is relatively small as will be described later. Accordingly, the possibility that the vehicle speed rapidly increases is small.

The mode determining unit 50b of the control unit 40 determines whether the MG cutoff mode should be performed while the vehicle travels. The mode determining unit 50b determines whether to perform the MG cutoff mode, for example, on the basis of the vehicle speed and the drive force. An example of the case in which the MG cutoff mode is performed is a low-load operation zone. In the low-load operation zone, for example, in the operation zone in which a request drive force for the vehicle 1 can be output by the output torque of the engine 2, it is thought that it is advantageous to separate the second rotary machine MG2 from the transmission member 11.

For example, in a zone with a high vehicle speed and a low load, the MG cutoff mode may be performed. In a high vehicle speed zone, the rotation speed of the engine 2 is relatively high and the engine 2 can be operated at an operating point at which the efficiency is good. In the high vehicle speed zone, the dragging loss or the mechanical loss occurring in the second rotary machine MG2 is likely to be large. In other words, there is a great merit obtained by separating the second rotary machine MG2 from the transmission member 11.

The mode determining unit 50b determines to which of the rest mode and the idling mode to transition when the MG cutoff mode is performed. The mode determining unit 50b in this embodiment determines which of the rest mode and the idling mode to perform on the basis of the vehicle speed. As described above, in this embodiment, shaft rotation speed Ns is proportional to the vehicle speed. Accordingly, the differential rotation speed ΔN between the shaft rotation speed Ns and the MG2 rotation speed Nm2 when the rest mode is performed can be estimated on the basis of the current vehicle speed. The mode determining unit 50b selects the idling mode when the estimated differential rotation speed ΔN is equal to or higher than the predetermined rotation speed N1. On the other hand, the mode determining unit 50b selects the rest mode when the estimated differential rotation speed ΔN is lower than the predetermined rotation speed N1. Accordingly, the control unit 40 stops the rotation of the second rotary machine MG2 when the rotation speed of the first dog-teeth 32 is lower than the predetermined rotation speed N1.

The cutoff mode instructing unit 50c instructs to perform the MG cutoff mode selected by the mode determining unit 50b and to return from the MG cutoff mode. In other words, the cutoff mode instructing unit 50c controls the engine 2 and the rotary machines MG1, MG2 through the use of the MG_ECU 60 and the engine ECU 70 depending on the MG cutoff mode selected by the mode determining unit 50b and the return mode.

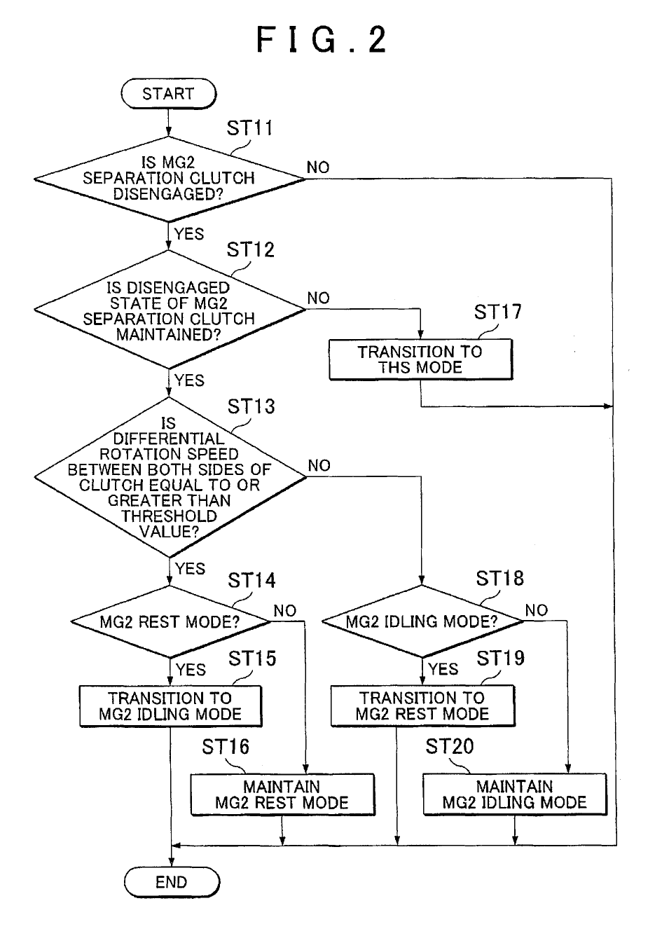

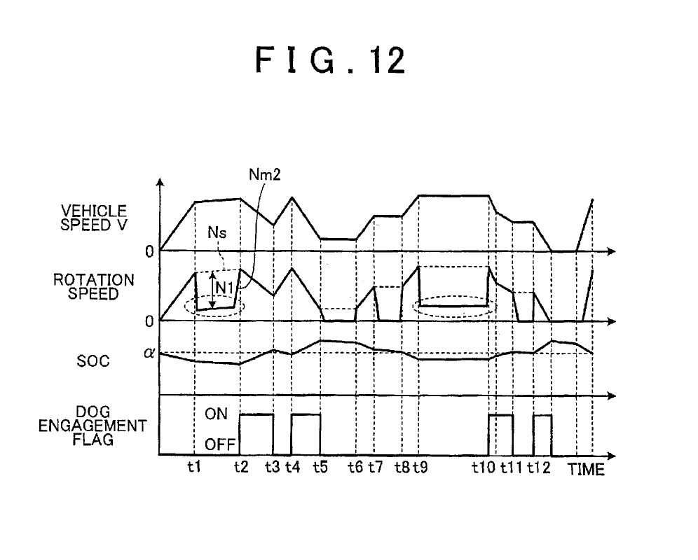

The control according to this embodiment will be described below with reference to FIGS. 1, 2, and 12. The control flow illustrated in FIG. 1 is repeatedly performed with a predetermined cycle, for example, while the vehicle 1 is traveling. The control flow illustrated in FIG. 2 is repeatedly performed with a predetermined cycle, for example, after the MG cutoff mode is started. In the timing chart illustrated in FIG. 12, the horizontal axis represents the time and the vertical axis sequentially represents the vehicle speed V, the rotation speed, the state of charge SOC of the battery 4, and the dog engagement flag from the top side. In the second timing chart from the top side in the vertical axis, the MG2 rotation speed Nm2 is indicated by a solid line and the shaft rotation speed Ns is indicated by a dotted line. In the state of charge SOC, a target value α in the HV running mode is determined. The control unit 40 controls the vehicle 1 so as to reduce the degree of separation between the state of charge SOC and the target value α. The dog engagement flag is an engagement flag associated with the first clutch CL1. When the dog engagement flag is in an ON state, the first clutch CL1 is engaged. On the other hand, when the dog engagement flag is in an OFF state, the first clutch CL1 is disengaged.

In step ST1 of FIG. 1, the HV_ECU 50 determines whether the engine 2 is operated. When it is determined in step ST1 that the engine 2 is operated (Y in step ST1), the control flow goes to step ST2 and ends otherwise (N in step ST1).

In step ST2, the mode determining unit 50b of the HVECU 50 determines whether the determination result of transition to the MG2-separated state is positive. In step ST2, it is determined whether transition to the MG cutoff mode is allowed. The mode determining unit 50b performs the determination of step ST2, for example, on the basis of the vehicle speed V and the request drive force calculated by the drive force calculating unit 50a. The mode determining unit 50b determines that the determination result of step ST2 is positive when a condition for allowing the performing of the MG cutoff mode is established. In this embodiment, an upper-limit drive force for allowing the performing of the MG cutoff mode is determined for each vehicle speed. The mode determining unit 50b allows the performing of the MG cutoff mode when the request drive force is equal to or less than the upper-limit drive force. When it is determined in step ST2 that the determination result of transition to the MG2-separated state is positive (Y in step ST2), the control flow goes to step ST3 and ends otherwise (N in step ST2).

In step ST3, the disengagement of the MG2 separation clutch is performed by the cutoff mode instructing unit 50c. The cutoff mode instructing unit 50c outputs a disengagement instruction to the first clutch CL1. The first clutch CL1 controls the actuator 35 in response to the disengagement instruction so as to disengage the first dog-teeth 32 and the second dog-teeth 33. When the first clutch CL1 is already disengaged, the disengaged state of the first clutch CL1 is maintained. The HV_ECU 50 sets the dog engagement flag to the OFF state when the first clutch CL1 is disengaged. After step ST3 is performed, step ST4 is performed.

In step ST4, the mode determining unit 50b determines whether the differential rotation speed between both sides of the clutch is equal to or higher than a threshold value. In step ST4, it is determined whether the differential rotation speed ΔN between the shaft rotation speed Ns and the MG2 rotation speed Nm2 is equal to or higher than the predetermined rotation speed N1. The mode determining unit 50b calculates the current shaft rotation speed Ns, for example, on the basis of the current vehicle speed and the gear ratio between the rotation shaft Sh and the driving wheels 25. The mode determining unit 50b may store a map representing the correlation between the vehicle speed and the shaft rotation speed Ns. The mode determining unit 50b calculates the differential rotation speed ΔN between the calculated shaft rotation speed Ns and the MG2 rotation speed Nm2. When the calculated differential rotation speed ΔN is equal to or higher than the predetermined rotation speed N1, the determination result of step ST4 is positive. The control flow goes to step ST5 when it is determined in step ST4 that the differential rotation speed between both sides of the clutch is equal to or higher than the threshold value (Y in step ST4), and the control flow goes to step ST6 otherwise (N in step ST4).

In step ST5, the mode determining unit 50b selects the transition to the idling mode. The mode determining unit 50b instructs the cutoff mode instructing unit 50c to perform the idling mode. The cutoff mode instructing unit 50c determines the target rotation speed of the second rotary machine MG2 in response to the instruction to transition to the idling mode. The target rotation speed is determined, for example, on the basis of the vehicle speed V as described with reference to FIG. 11. The target rotation speed is output to the MG_ECU 60. The MG_ECU 60 controls the second rotary machine MG2 so as to set the target rotation speed to the MG2 rotation speed Nm2. After step ST5 is performed, the control flow ends.

In step ST6, the mode determining unit 50b selects the transition to the rest mode. The mode determining unit 50b instructs the cutoff mode instructing unit 50c to perform the rest mode. The cutoff mode instructing unit 50c instructs the MG_ECU 60 to stop the rotation of the second rotary machine MG2 in response to the instruction to transition to the rest mode. The MG_ECU 60 controls the second rotary machine MG2 so as to stop the rotation of the second rotary machine MG2, for example, by setting the target rotation speed of the second rotary machine MG2 to 0. After step ST6 is performed, the control flow ends.

After the MG cutoff mode is started, it is determined whether to maintain the MG cutoff mode, which of the rest mode and the idling mode to perform when the MG cutoff mode is maintained, and the like on the basis of the flowchart illustrated in FIG. 2.

In step ST11 of FIG. 2, the mode determining unit 50b determines whether the MG2 separation clutch is in the disengaged state. When the first clutch CL1 is in the disengaged state, the mode determining unit 50b determines that the determination result of step ST11 is positive. The determination of whether the first clutch CL1 is in the disengaged state can be performed, for example, on the basis of the value of the differential rotation speed ΔN between the shaft rotation speed Ns and the MG2 rotation speed Nm2, but may be performed on the basis of the value of the dog engagement flag instead. The control flow goes to step ST12 when it is determined in step ST11 that the MG2 separation clutch is in the disengaged state (Y in step ST11), and the control flow ends otherwise (N in step ST11).

In step ST12, the mode determining unit 50b determines whether to maintain the disengaged state of the MG2 separation clutch. The mode determining unit 50b determines that the determination result of step ST12 is positive when a condition for allowing the performing of the MG cutoff mode is established. The control flow goes to step ST13 when it is determined in step ST12 that the disengaged state of the MG2 separation clutch is maintained (Y in step ST12), and the control flow goes to step ST17 otherwise (N in step ST12).

In step ST13, the mode determining unit 50b determines whether the differential rotation speed between both sides of the clutch is equal to or higher than a threshold value. The mode determining unit 50b calculates the differential rotation speed ΔN, for example, in the same way as in step ST4. When the value of the differential rotation speed ΔN is equal to or higher than the predetermined rotation speed N1, the determination result of step ST13 is positive. The control flow goes to step ST14 when it is determined in step ST13 that the differential rotation speed between both sides of the clutch is equal to or higher than the threshold value (Y in step ST13), and the control process goes to step ST18 (N in step ST13).

In step ST14, the mode determining unit 50b determines whether the MG2 rest mode is being performed. When the rest mode is being performed, the determination result of step ST14 is positive. The control flow goes to step ST15 when it is determined in step ST14 that the MG2 rest mode is being performed (Y in step ST14), and the control flow goes to step ST16 otherwise (N in step ST14).

In step ST15, the mode determining unit 50b determines whether to transition to the MG2 idling mode. The mode determining unit 50b instructs the cutoff mode instructing unit 50c to perform the idling mode. The cutoff mode instructing unit 50c instructs the MG_ECU 60 to rotate the second rotary machine MG2 at the target rotation speed in response to the instruction to perform the idling mode. At this time, the target rotation speed is determined, for example, as described with reference to FIG. 11. After step ST15 is performed, the control flow ends.

In step ST16, the mode determining unit 50b determines whether to maintain the MG2 rest mode. The mode determining unit 50b instructs the cutoff mode instructing unit 50c to perform the rest mode. After step ST16 is performed, the control flow ends.

In step ST18, the mode determining unit 50b determines whether the MG2 idling mode is being performed. When the idling mode is being performed, the determination result of step ST18 is positive. The control flow goes to step ST19 when it is determined in step ST18 that the MG2 idling mode is being performed (Y in step ST18), and the control flow goes to step ST20 otherwise (N in step ST18).

In step ST19, the mode determining unit 50b determines whether to transition to the MG2 rest mode. The mode determining unit 50b instructs the cutoff mode instructing unit 50c to perform the rest mode. The cutoff mode instructing unit 50c instructs the MG_ECU 60 to stop the rotation of the second rotary machine MG2 in response to the instruction to perform the rest mode. After step ST19 is performed, the control flow ends.

In step ST20, the mode determining unit 50b determines whether to maintain the MG2 idling mode. The mode determining unit 50b instructs the cutoff mode instructing unit 50c to perform the idling mode. After step ST20 is performed, the control flow ends.

When the determination result of step ST12 is negative and the control flow goes to step ST17, the mode determining unit 50b determines whether to transition to the THS mode in step ST17. The mode determining unit 50b instructs the cutoff mode instructing unit 50c to return from the MG cutoff mode to the THS mode. The cutoff mode instructing unit 50c performs the return mode in response to the instruction to return. The cutoff mode instructing unit 50c instructs the MG_ECU 60 to increase the MG2 rotation speed Nm2 to the shaft rotation speed Ns. When the MG2 rotation speed Nm2 is increased to the shaft rotation speed Ns by the control of the MG_ECU 60, the second clutch CL2 is engaged and power in the positive rotation direction can be transmitted from the second rotary machine MG2 to the transmission member 11. When the MG2 rotation speed Nm2 is synchronized with the shaft rotation speed Ns, the cutoff mode instructing unit 50c determines that the return from the MG cutoff mode is completed.

In the return, the first clutch CL1 may be engaged. When the MG2 rotation speed Nm2 is synchronized with the shaft rotation speed Ns, the cutoff mode instructing unit 50c instructs the first clutch CL1 to be engaged. The first clutch CL1 drives the sleeve 34 in response to the engagement instruction and engages the first dog-teeth 32 and the second dog-teeth 33. When the first clutch CL1 is engaged, the cutoff mode instructing unit 50c sets the dog engagement flag to the ON state and determines that the return from the MG cutoff mode is completed.

When the return from the MG cutoff mode is completed, the HV_ECU 50 starts the THS mode, that is, the HV running mode using the engine 2 and the second rotary machine MG2 as a drive source. The HV_ECU 50 determines the command value of the engine torque and the torque command values of the rotary machines MG1, MG2 on the basis of the request drive force calculated by the drive force calculating unit 50a and outputs the command values to the MG_ECU 60 and the engine ECU 70. After step ST17 is performed, the control flow ends.

The operation of the vehicle 1 that is controlled on the basis of the control flow of FIGS. 1 and 2 will be described below with reference to FIG. 12. At time t1, the determination result of step ST2 of FIG. 1 is positive and the MG cutoff mode is started. At this time, the dog engagement flag is set to the OFF state and the first clutch CL1 is disengaged. The cutoff mode instructing unit 50c decreases the MG2 rotation speed Nm2, for example, by causing the second rotary machine MG2 to perform the regenerative power generation. In the period from time a to t2, the vehicle speed is relatively high and the shaft rotation speed Ns is high. Accordingly, the determination result of step ST4 is positive and the running mode transitions to the idling mode, before the MG2 rotation speed Nm2 decreases to 0.

Prior to time t2, the determination of whether to return from the MG cutoff mode is performed (N in step ST12 of FIG. 2). At this time, the return determination is based on the driver's braking operation or the deceleration request from the vehicle 1. The deceleration request from the vehicle 1 is, for example, based on running conditions such as a condition in which a downhill road is detected or a condition in which the inter-vehicle distance from a preceding vehicle is shortened. The cutoff mode instructing unit 50c instructs to increase the MG2 rotation speed Nm2 on the basis of the return determination. At time t2, when the MG2 rotation speed Nm2 is synchronized with the shaft rotation speed Ns, the first clutch CL1 is engaged and the dog engagement flag is switched to the ON state. The HV_ECU 50 causes the second rotary machine MG2 to perform the regenerative power generation and to generate a braking force.

At time t3, when the deceleration is switched to acceleration, the HV_ECU 50 disengages the first clutch CL1. Accordingly, the power consumption in the first clutch CL1 is suppressed. When the deceleration is performed at time t4, the HV_ECU 50 engages the first clutch CL1 and causes the second rotary machine MG2 to perform the regenerative power generation.

At time t5, it is determined whether to transition to the MG cutoff mode. In the period from time t5 to time t6, the vehicle speed is low and the shaft rotation speed Ns is also low. Accordingly, the running mode transitions to the rest mode and the rotation of the second rotary machine MG2 is stopped. Similarly, in the period from time t7 to time t8 and the period from time t11 to time t12, the rest mode is performed. On the other hand, in the period from time t9 to time t10, the vehicle speed is high and thus the idling mode is performed.

As described above, the vehicle control system 100 according to this embodiment includes the idling mode. The control unit 40 switches the running mode between the idling mode and the rest mode depending on the differential rotation speed ΔN between the shaft rotation speed Ns and the MG2 rotation speed Nm2. In this way, in the vehicle control system 100 according to this embodiment, the second rotary machine MG2 is prepared in the rotating state for an acceleration request. Accordingly, the vehicle control system 100 can achieve the effect of suppressing the degradation in acceleration responsiveness.

In order to guarantee the acceleration responsiveness at the time of return from the rest mode, a countermeasure of increasing a current value or a voltage value supplied to the second rotary machine MG2 can be considered. However, when this countermeasure is taken, the energy consumption of the second rotary machine MG2 may increase, the effect of fuel combustion improvement may degrade, or the like. According to this embodiment, the operation zone (for example, vehicle speed zone) in which the MG cutoff mode can be performed can be enlarged in comparison with a case in which only the rest mode is provided. According to this embodiment, it is possible to cause the reduction in dragging loss due to the performing of the MG cutoff mode and the acceleration responsiveness to be compatible with each other.

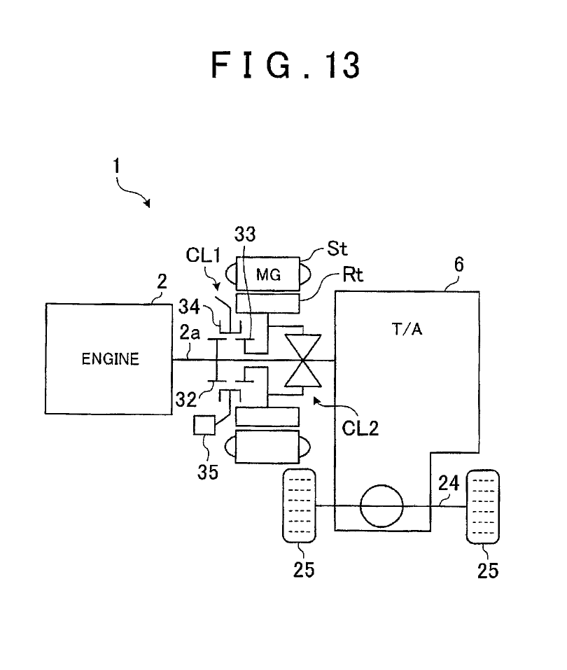

A first modification example of the embodiment will be described below. A vehicle 1 to which the vehicle control system 100 according to the above-mentioned embodiment can be applied is not limited to the vehicle exemplified in the above-mentioned embodiment. For example, the vehicle control system 100 can be applied to the vehicle 1 according to the first modification example. FIG. 13 is a skeleton diagram illustrating the vehicle according to the first modification example of the embodiment.

As illustrated in FIG. 13, the vehicle 1 according to the first modification example includes an engine 2, a rotary machine MG, and a transaxle 6. The rotary machine is disposed coaxial with the output shaft 2a of the engine 2. The rotary machine MG includes a rotor Rt that is rotatably supported and a stator St fixed to the vehicle body side. The first clutch CL1 is disposed between the output shaft 2a and the rotary machine MG. The first dog-teeth 32 is connected to the output shaft 2a. The second dog-teeth 33 is connected to the rotor Rt of the rotary machine MG. Similarly to the first clutch CL1 in the above-mentioned embodiment, the first clutch CL1 arbitrarily engages or disengages the first dog-teeth 32 and the second dog-teeth 33 through the use of the sleeve 34 and the actuator 35. The second clutch CL2 is disposed in parallel to the first clutch CL1. The transaxle 6 is connected to the opposite side of the output shaft 2a to the engine 2. The transaxle 6 is, for example, stepped or stepless mechanical gear shift mechanism. That is, the rotation of the output shaft 2a is changed in speed and is output to the drive shaft 24.

The vehicle 1 according to this modification example is equipped with the same vehicle control system 100 as the vehicle control system 100 (FIGS. 3, 5) according to the above-mentioned embodiment. In the vehicle 1 according to this modification example, the control unit 40 of the vehicle control system 100 performs the idling mode in which the vehicle waits with the first clutch CL1 disengaged while the vehicle travels and with the rotary machine MG rotating in a state in which the rotation speed of the second dog-teeth 33 is lower than the rotation speed of the first dog-teeth 32. The control unit 40 performs the rest mode or the return mode similarly to the above-mentioned embodiment.

In the vehicle 1 according to this modification example, the gear shift mechanism is disposed between the first dog-teeth 32 and the driving wheels 25. Accordingly, the gear ratio of the first dog-teeth 32 and the driving wheels 25 varies depending on the gear shift ration. Accordingly, the mode determining unit 50b can calculate the rotation speed of the first dog-teeth 32 depending on the transaxle 6, when calculating the differential rotation speed ΔN between the rotation speed of the first dog-teeth 32 and the rotation speed of the second dog-teeth 33. In this modification example, it is preferable that the target value of the rotation speed of the rotary machine MG be determined depending on the rotation speed of the first dog-teeth 32. That is, it is preferable that the target value of the rotary machine MG be determined so that the differential rotation speed ΔN between the rotation speed of the first dog-teeth 32 and the rotation speed of the rotary machine MG.

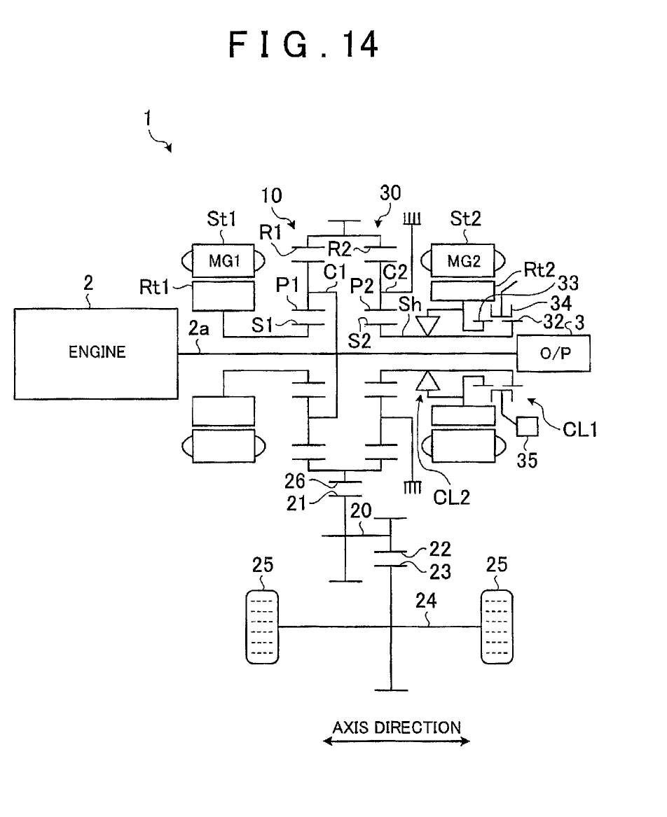

A second modification examples of the above-mentioned embodiments will be described below. FIG. 14 is a skeleton diagram illustrating the vehicle according to a second modification example of the embodiment. The transaxle (FIG. 4) according to this embodiment is of a multi-axis type in which the output shaft 2a of the engine 2 and the rotation shaft Sh of the second rotary machine MG2 are located in different axes. The transaxle according to the second modification example is different from that in the above-mentioned embodiment, in that the engine 2 and the second rotary machine MG2 are disposed coaxial with each other.

As illustrated in FIG. 14, a first rotary machine MG1, a planetary gear mechanism 10, a second planetary gear mechanism 30, a second rotary machine MG2, and an oil pump 3 are arranged coaxial with the engine 2 sequentially from the side close to the engine 2. The planetary gear mechanism 10 is the same single-pinion planetary gear mechanism as the planetary gear mechanism 10 of the above-mentioned embodiment. The planetary gear mechanism 10 includes a sun gear S1, a pinion gear P1, a ring gear R1, and a carrier C1. The sun gear S1 is connected to the rotor Rt1 of the first rotary machine MG1. The carrier C1 is connected to the output shaft 2a of the engine 2.

The second planetary gear mechanism 30 is a single-pinion planetary gear mechanism and includes a second sun gear S2, a second pinion gear P2, a second ring gear R2, and a second carrier C2. The second sun gear S2 is connected to the rotation shaft Sh and rotates along with the rotation shaft Sh. The second carrier C2 is fixed to the vehicle body side and cannot rotate. The second ring gear R2 is connected to the ring gear R1 and rotates along with the ring gear R1. A common output gear 26 is disposed on the outer circumferences of the ring gear R1 and the second ring gear R2. The output gear 26 engages with a driven gear 21. The configurations of from the driven gear 21 to the driving wheels 25 may be the same as the configuration of the vehicle 1 according to the above-mentioned embodiment.

A first clutch CL1 and a second clutch CL2 are disposed between the rotation shaft Sh and the rotor Rt2 of the second rotary machine MG2. The second clutch CL2 is disposed in parallel to the first clutch CL1. The configurations of the first clutch CL1 and the second clutch CL2 may be the same as in the above-mentioned embodiment. For example, the first dog-teeth 32 are connected to the rotation shaft Sh and the second dog-teeth 33 are connected to the rotor Rt2. In the vehicle 1 according to this modification example, the positive rotation direction of the second rotary machine MG2 is opposite to the rotation direction of the output gear 26 when the vehicle 1 travels forward. The vehicle 1 according to this modification example is equipped with the same vehicle control system 100 as the vehicle control system 100 (FIGS. 3, 5) according to the above-mentioned embodiment. In the vehicle 1 according to this modification example, the vehicle control system 100 can perform the same control as in the above-mentioned embodiment and can achieve the same advantages.

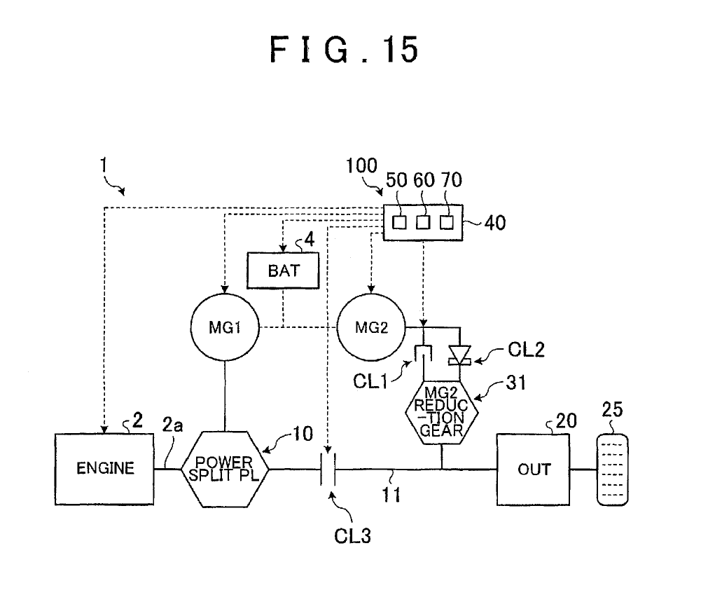

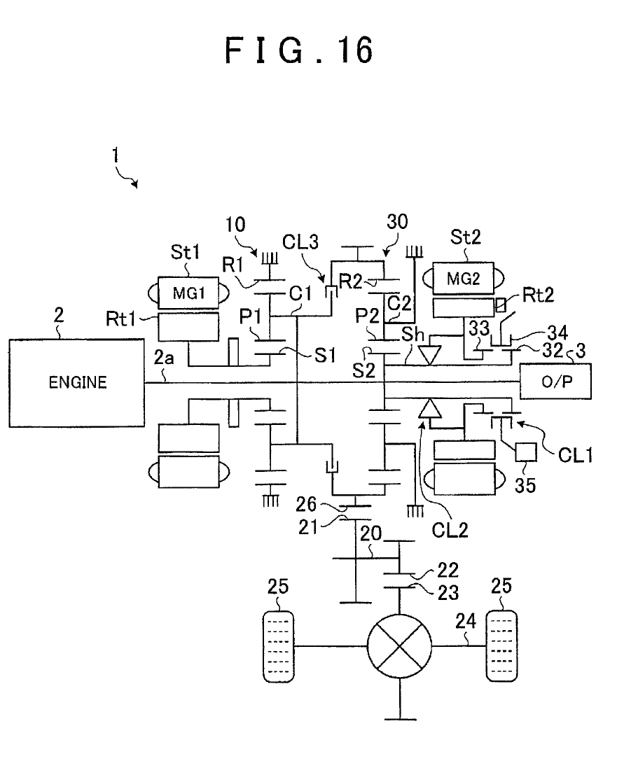

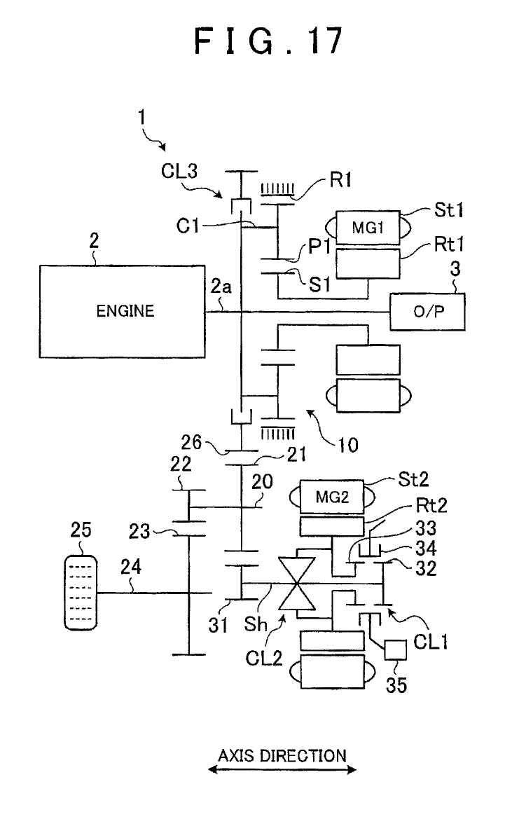

A third modification example of the embodiment will be described below. FIG. 15 is a diagram schematically illustrating the configuration of a vehicle according to the third modification example of the embodiment and FIG. 16 is a skeleton diagram illustrating the vehicle according to the third modification example. This modification example is different from the above-mentioned embodiment, in that parallel hybrid and series hybrid can be switched.

As illustrated in FIG. 15, a transmission member 11 is provided with a third clutch CL3. The third clutch CL3 connects and disconnects the side of the engine 2 and the first rotary machine MG1 and the side of the driving wheels 25 and the second rotary machine MG2. The third clutch CL3 is, for example, a frictional engagement type clutch or a meshing type clutch that can be switched between an engaged state and a disengaged state. The third clutch CL3 is controlled by the control unit 40.

When the third clutch CL3 is engaged, the side of the engine 2 and the first rotary machine MG1 and the side of the driving wheels 25 and the second rotary machine MG2 are connected to each other. Accordingly, similarly to the vehicle 1 according to the above-mentioned embodiment, a parallel hybrid running mode using the torque of the engine 2 and the torque of the second rotary machine MG2 as the drive source of the vehicle 1 can be performed. On the other hand, when the third clutch CL3 is disengaged, the transmission of power between the side of the engine 2 and the first rotary machine MG1 and the side of the driving wheels 25 and the second rotary machine MG2 is intercepted. In this case, the torque of the engine 2 is used to rotationally drive the first rotary machine MG1 to cause the first rotary machine MG1 to generate electric power. The electric power generated by the first rotary machine MG1 is converted into power to drive the vehicle 1 by the second rotary machine MG2. That is, when the third clutch CL3 is disengaged, a series hybrid running mode can be performed.

The vehicle 1 according to this modification example is equipped with the same vehicle control system 100 as the vehicle control system 100 (FIGS. 3, 5) according to the above-mentioned embodiment. In this modification example, the vehicle control system 100 additionally has a function of controlling the third clutch CL3. In the vehicle 1 according to this modification example, the vehicle control system 100 can perform the same control as in the above-mentioned embodiment and can achieve the same advantages. The control unit 40 can perform the MG cutoff mode, for example, without depending on whether the third clutch CL3 is engaged. Alternatively, in the vehicle 1 according to this modification example, the MG cutoff mode may be allowed only when the third clutch CL3 is engaged.

An example of the specific configuration of the vehicle 1 according to the third modification example is illustrated in FIG. 16. The third clutch CL3 is disposed between the planetary gear mechanism 10 and the output gear 26. Specifically, the third clutch CL3 is disposed between the carrier C1 and the output gear 26 and the second ring gear R2. The sun gear S1 of the planetary gear mechanism 10 is connected to the rotor Rt1 of the first rotary machine MG1. The carrier C1 is connected to the output shaft 2a of the engine 2 and the third clutch CL3. The ring gear R1 is fixed to the vehicle body side and cannot rotate. The other configuration may be the same as the configuration of the vehicle 1 (FIG. 14) according to the second modification example.

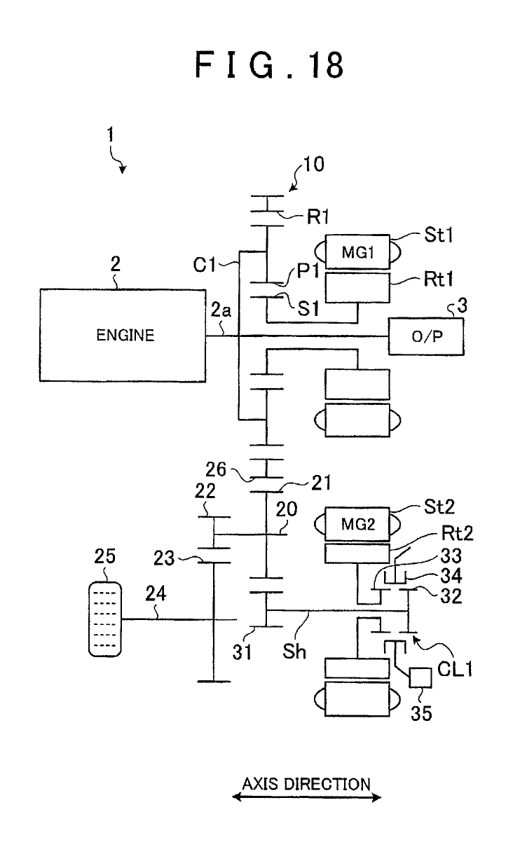

FIG. 17 is a diagram another example of the configuration of the vehicle according to the third modification example of the embodiment. The vehicle 1 illustrated in FIG. 17 has a multi-axis arrangement in which the engine 2, the output shaft 20, and the second rotary machine MG2 are arranged in different axes. The third clutch CL3 connects and disconnects the output shaft 2a of the engine 2 and the output gear 26. The planetary gear mechanism 10, the first rotary machine MG1, and the like are connected to the side closer to the engine 2 than the third clutch CL3. The output shaft 20, the rotation shaft Sh, the second rotary machine MG2, the first clutch CL1, the second clutch CL2, and the like are connected to the side closer to the driving wheels 25 than the third clutch CL3. The rotor Rt1 of the first rotary machine MG1 is connected to the sun gear S1 of the planetary gear mechanism 10. The carrier C1 is connected to the output shaft 2a and the third clutch CL3. The ring gear R1 is fixed to the vehicle body side and cannot rotate. Accordingly, in the vehicle 1 illustrated in FIG. 17, the rotation of the engine 2 is increased in speed by the planetary gear mechanism 10 and is transmitted to the first rotary machine MG1.

The output gear 26 is disposed between the engine 2 and the planetary gear mechanism 10 in the axis direction. The output gear 26 is rotatably supported to be coaxial with the engine 2. The third clutch CL3 includes an engagement element connected to the output shaft 2a and the carrier C1 and an engagement element connected to the output gear 26. The configuration of the side closer to the driving wheels 25 than the output gear 26 may be the same as the configuration of the vehicle 1 according to the above-mentioned embodiment.

In the vehicle illustrated in FIG. 17, when the third clutch CL3 is engaged, a parallel hybrid running mode can be performed. When the third clutch CL3 is disengaged, a series hybrid running mode can be performed.

A fourth modification example of the above-mentioned embodiment will be described below. In the above-mentioned embodiment and the above-mentioned modification examples, the second clutch CL2 may be removed. FIG. 18 is a skeleton diagram illustrating the vehicle according to the fourth modification example of the embodiment. In the vehicle 1 illustrated in FIG. 18, the second clutch CL2 is removed from the vehicle 1 (FIG. 4) according to the above-mentioned embodiment.

The vehicle 1 according to this modification example is different from the vehicle 1 according to the above-mentioned embodiment, for example, in the following points. (1) When the vehicle 1 travels using the second rotary machine MG2 as a drive source, it is necessary to engage the first clutch CL1. (2) When the first clutch CL1 is disengaged, the MG2 rotation speed Nm2 can be set to be lower than the shaft rotation speed Ns and can also be set to be higher than the shaft rotation speed Ns. (3) When the running mode is returned from the rest mode or the idling mode, it is necessary to engage the first clutch CL1 as well as to synchronize the MG2 rotation speed Nm2 with the shaft rotation speed Ns.

The control unit 40 switches the first clutch CL1 to the engaged state, when accelerating the vehicle 1 with the torque of the second rotary machine MG2 or when causing the second rotary machine MG2 to perform the regenerative power generation. By engaging the first clutch CL1, it is possible to transmit the torque in any direction generated by the second rotary machine to the transmission member 11. The control unit 40 may maintain the engaged state of the first clutch CL1, except for the case in which the MG cutoff mode is performed.

The vehicle 1 according to this modification example can be equipped with the same vehicle control system 100 as the vehicle control system 100 according to the above-mentioned embodiment. The vehicle control system 100 performs the MG cutoff mode including the idling mode and the rest mode depending on the running condition of the vehicle 1 or the like. The condition for allowing the performing of the MG cutoff mode is appropriately determined depending on the configuration of the vehicle 1.

The operation in the return mode of the vehicle 1 according to this modification example will be described below. The vehicle 1 according to this modification example does not include the second clutch CL2 and thus requires the operation of engaging the first clutch CL1 when the running mode is returned from the MG cutoff mode. For example, when the determination result of step ST12 of the control flow illustrated in FIG. 2 is negative, the return mode is performed in step ST17. The control unit 40 controls the second rotary machine MG2 so as to increase the MG2 rotation speed Nm2 in the return mode. The control unit 40 engages the first clutch CL1 when the differential rotation speed ΔN between the MG2 rotation speed Nm2 and the shaft rotation speed Ns is equal to or lower than a predetermined value. When the first clutch CL1 is engaged, the transition to the HV running mode (the return from the MG cutoff mode) is completed.

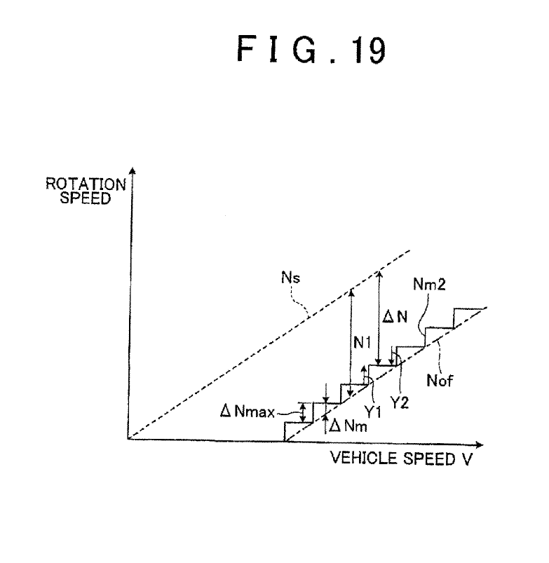

A fifth modification example of the above-mentioned embodiment will be described below. FIG. 19 is a diagram illustrating the idling mode according to the fifth modification example of the embodiment. In the above-mentioned embodiment, the MG2 rotation speed Nm2 is controlled so as to maintain the differential rotation speed ΔN between the shaft rotation speed Ns and the MG2 rotation speed Nm2 at the predetermined rotation speed N1. A reference rotation speed Nof indicated by a one-dot chain line in FIG. 19 is the target value of the MG2 rotation speed Nm2 in the above-mentioned embodiment, that is, a rotation speed at which the differential rotation speed ΔN from the shaft rotation speed Ns is equal to the predetermined rotation speed N1. The shaft rotation speed Ns and the reference rotation speed Nof are parallel to each other and the value of the shaft rotation speed Ns is greater by the predetermined rotation speed N1 than the value of the reference rotation speed Nof at the same vehicle speed.

In this modification example, the MG2 rotation speed Nm2 is controlled so that the difference ΔNm (=Nm2−Nof) between the MG2 rotation speed Nm2 and the reference rotation speed Nof is equal to or less than a maximum value ΔNmax. The command value of the MG2 rotation speed Nm2 is a value equal to or greater than the reference rotation speed Nof. Accordingly, the differential rotation speed ΔN between the shaft rotation speed Ns and the MG2 rotation speed Nm2 is equal to or less than the predetermined rotation speed N1. Accordingly, the degradation in responsiveness when the running mode is switched from the idling mode to the HV running mode via the return mode is suppressed.

In this modification example, for example, illustrated in FIG. 19, the MG2 rotation speed Nm2 is increased in a step-like manner with the increase in the vehicle speed. The control unit 40 maintains the MG2 rotation speed Nm2 when the difference ΔNm between the MG2 rotation speed Nm2 and the reference rotation speed Nof satisfies Expression (1).

0≦ΔNm≦ΔNmax (1)

On the other hand, the control unit 40 changes the MG2 rotation speed Nm2 when the difference ΔNm does not satisfy Expression (1). For example, when the difference ΔNm is less than 0, the control unit 40 increases the MG2 rotation speed Nm2 by the maximum value ΔNmax. Accordingly, when the MG2 rotation speed Nm2 is less than the reference rotation speed Nof due to the increase in the vehicle speed, the command value of the MG2 rotation speed Nm2 increases as indicated by an arrow Y1. The control unit 40 decreases the MG2 rotation speed Nm2 by the maximum value ΔNmax when the difference ΔNm is greater than the maximum value ΔNmax. Accordingly, when the difference ΔNm is greater than the maximum value ΔNmax due to the decrease in the vehicle speed, the command value of the MG2 rotation speed Nm2 can be decreased to the reference rotation speed Nof at that vehicle speed as indicated by an arrow Y2. In this way, when the MG2 rotation speed Nm2 is changed in a step-like manner, it is possible to suppress the loss due to the frequent change of the MG2 rotation speed Nm2.

The method of determining the MG2 rotation speed Nm2 is not limited to the methods described in the above-mentioned embodiment or this modification example. For example, the predetermined rotation speed N1 may be set to be variable depending on conditions. For example, the maximum torque that can be output from the second rotary machine MG2 may vary depending on the MG2 rotation speed Nm2. In this case, the predetermined rotation speed N1 may be determined on the basis of the output characteristics of the second rotary machine MG2 so that the time required for increasing the MG2 rotation speed Nm2 in the return mode is constant. For example, when the second rotary machine MG2 has a characteristic that the value of the maximum MG2 torque Tm2 that can be output in a high-rotation zone is less than in a low-rotation zone, the value of the predetermined rotation speed N1 in the high-rotation zone may be less than the value of the predetermined rotation speed N1 in the low-rotation zone.

The predetermined rotation speed N1 may vary depending on requested acceleration performance. For example, a vehicle 1 is known in which the requested acceleration performance can be set by a driver. For example, in case of a vehicle having a normal mode and an economic mode in which the fuel efficiency improvement has prior to the normal mode, the value of the predetermined rotation speed N1 in the economic mode may be greater than the value of the predetermined rotation speed N1 in the normal mode.

A sixth modification example of the above-mentioned embodiment will be described below. The first clutch CL1 is not limited to the above-mentioned meshing type clutch, and may employ a friction type clutch. The first clutch CL1 may employ, for example, a wet or dry multi-disk clutch. The second clutch CL2 is not limited to the above-mentioned sprag type one-way clutch, and may be another type one-way clutch. That is, the second clutch CL2 only has to have a function of transmitting a torque in one direction from one engagement element to the other engagement element and intercepting the transmission of a torque in the other direction.

The condition for allowing or inhibiting the MG cutoff mode is not limited to the conditions based on the vehicle speed or the drive force. Whether to perform the MG cutoff mode may be determined on the basis of other conditions.

The details described in the above-mentioned embodiment and the above-mentioned modification examples may be appropriately combined for practice.

1. A controller for a vehicle, the vehicle including an engine, a rotary machine, at least one driving wheel, a transmission member arranged between the engine and the driving wheel, and a clutch including a first engagement element connected to the transmission member and a second engagement element connected to the rotary machine, the clutch being configured to engage or disengage the first engagement element and the second engagement element, the controller comprising:
an electronic control unit configured to perform an idling mode after the clutch is disengaged while the vehicle is traveling, the idling mode being a mode in which the rotary machine rotates in a state where a rotation speed of the second engagement element is lower than a rotation speed of the first engagement element, and the electronic control unit is configured to stop a rotation of the rotary machine when the rotation speed of the first engagement element is lower than a predetermined value while performing the idling mode.

2-5. (canceled)

6. The controller according to claim 1, wherein
the electronic control unit is configured to control the rotary machine so as to raise the rotation speed of the second engagement element when the electronic control unit determines that a braking operation is performed by a driver or a deceleration request is given.

7. A control method for a vehicle, the vehicle including an engine, a rotary machine, at least one driving wheel, a transmission member arranged between the engine and the driving wheel, a clutch including a first engagement element connected to the transmission member and a second engagement element connected to the rotary machine, the clutch being configured to engage or disengage the first engagement element and the second engagement element, and an electronic control unit, the control method comprising:
performing, by the electronic control unit, an idling mode after the clutch is disengaged while the vehicle is traveling, the idling mode being a mode in which the rotary machine rotates in a state where a rotation speed of the second engagement element is lower than a rotation speed of the first engagement element, and the electronic control unit is configured to stop a rotation of the rotary machine when the rotation speed of the first engagement element wer than a predetermined value while performing the idling mode.

8. A control system for a vehicle comprising:
an engine;
a rotary machine;
at least one driving wheel;
a transmission member arranged between the engine and the driving wheel, and a clutch including a first engagement element connected to the transmission member and a second engagement element connected to the rotary machine, the clutch being configured to engage or disengage the first engagement element and the second engagement element; and
an electronic control unit configured to perform an idling mode after the clutch is disengaged while the vehicle is traveling, the idling mode being a mode in which the rotary machine rotates in a state where a rotation speed of the second engagement element is lower than a rotation speed of the first engagement element, and the electronic control unit is configured to stop a rotation of the rotary machine when the rotation speed of the first engagement element is lower than a predetermined value while performing the idling mode.

9. The control system according to claim 8, further comprising:
a one-way clutch disposed in parallel to the clutch, and the one-way clutch being configured to be disengaged while performing the idling mode.
